(19) United States
(12) Patent Application Publication
(10) Pub. No.: US 2015/0369677 A1
(43) Pub. Date: Dec. 24, 2015

(54) SENSOR HAVING SIMPLE CONNECTION TECHNOLOGY

(71) Applicant: EvoSense Research & Development GmbH, D-64283 Darmstadt (DE)

(72) Inventors: Roland Werthschützky, Kleinmachnow (DE); Thorsten Meiss, Darmstadt (DE); Jacqueline Rausch, Lohr-Sackenbach (DE); Tim Rossner, Alzenau (DE); Felix Greiner, Schwalmstadt (DE)

(73) Assignee: EvoSense Research & Development GmbH, D-64283 Darmstadt (DE)

(21) Appl. No.: 14/420,742

(22) PCT Filed: Aug. 9, 2013
(86) PCT No.: PCT/DE2013/100287

§ 371 Date: Aug. 27, 2015

(30) Foreign Application Priority Data
Aug. 10, 2012 (DE) 10 2012 015 797.5

(51) Int. Cl. G01L 1/26

(52) U.S. Cl. CPC G01L 1/26; G01L 1/2206

(57) ABSTRACT

The invention permits the particularly simple, rapid and economic application of measuring elements (100) to objects to be measured (200). This is ensured by means of the integration of a functional material (140) on the connecting surface (113) of a measuring element (100). The mechanical connection is produced by activating the functional material (140). In this way, for example, the application times for strain sensors are drastically reduced. Furthermore, a defined thickness of the remaining functional material (140) is implemented and therefore reproducible properties of the connection are ensured.

The invention relates to the technology of connecting measuring elements with measurement objects.

In numerous application areas, there is the problem of mounting an electrical component on a surface.

Especially in the area of strain measurement, strain gauges (DMS) are used. For example, metal film strain gauges are bonded onto surfaces. For this purpose, it is necessary to clean the surface and the metal film strain gauge and to provide a defined amount of adhesive. The adhesive is cured by pressure and/or temperature exposure. This represents a special difficulty, in particular for bodies with large dimensions. Compared to the metal of the metal film gages adhesives have a lower shear strength. The cleaning of the surfaces must be made meticulously as surface layers take influence on the adhesion strength and the strain transfer. Summing up, the process of bonding is complicated and expensive.

In addition to adhesives, compounds with higher shear strength are used for semiconductor strain gauges. For example the bonding by means of a glass interlayer is known. Therefore, a glass layer of defined thickness is applied onto a metallic deformation body. Under the influence of temperature, the glass is liquefied and a connection between the deformation body and the strain measurement element results. Particularly problematic for the electrical contacting are the high process temperatures over an extended time period. Thus, an electrical contact of the strain gauge element prior to mechanical bonding, for example via flexible conductor strips (flexible conductors) is not possible, since this electrical connection would be slackened in the mechanical bonding process due to the influence of temperature. Likewise, the installation of a plurality of strain measuring elements on a body, in particular on a body having surfaces aligned in different directions, is especially difficult.

Therefore a mechanical fixation of the measuring elements has to be provided during the mechanical bonding process, so that the elevated temperature does not cause the detachment of the elements to be applied.

Own research led to new types of strain gauges [1]. Currently, there are also commercial strain gauges with resistors, for example, the “T-bridge” of the company First Sensor Technology [2]. However, it is not possible to contact this member in the manufacturing process primarily and then install it by means of a high-temperature process.

It is therefore the object of the present invention to describe an electrical component which can be mounted with high mechanical stability on various surfaces by means of a prepared, locally acting bonding step with exactly predictable characteristics in a very simple way, whereby the electrical contact shall be performed prior to the mechanical bonding step.

The invention is achieved in the following way that a pre-structured intermediate layer is implemented between the component and the surface to which the component is bonded.

For example this may be realized by an intermediate layer with a functional material which causes an exothermic reaction and therefore the welding or soldering of the bonding partners.

Alternatively, a connection process of measuring element and the measurement object can be performed by a pre-prepared adhesive compound layer. The electrical contact at the top has to be built in that way that the contact is not disrupted during the installation process and remains functional thereafter.

In the field of assembly bonding techniques utilizing exothermic reactions have long been state of the art. For example, a mixture of iron oxide and aluminum is used for welding of rails in railway transportation. By ignition of the mixture, aluminum is oxidized and at the same time iron oxide is reduced to iron, whereby the iron leads to the welding of the rail joints.

In the assembly of micro-components there are solutions for bonding surfaces by means of reactive nano-films. For example, the company Indium Corporation [3] provides nano-films which can be used for soldering primed silicon chips onto certain metal surfaces. This method is used to bond components with high power dissipation onto metal surfaces, whereby the resulting loss of heat is conducted well through the connection layer. The electrical contacting of the components is done following this mechanical assembly step. So far, however, no component is known, which combines the advantages of mechanical fastening means of reactive layers but previously establishing electrical contact.

The procedures of the prior art are thus not suitable for providing a bonding having high mechanical shear strength, which is effected at high temperatures greater than 200° C. , and which allows to assemble the elements in the field one after another (in series) due to the local action of heat only.

A novel solution that simplifies the installation of integrated strain gauge elements in practical use—which means in the lab, in production and in the field—is disclosed below.

The present invention allows for the first time

attaching electrical contacts of the components by the manufacturer prior to installation,

high shear strength of the bond layer,

a serial assembly process with an extremely short period of time,

a reduction of the effort to prepare the bond surfaces and

the adaptation to a variety of materials and surface structures.

The object of the invention is to provide a member having a primed mechanical bonding area with a defined intermediate layer thickness, as well as an electrically robust contact area so that the electrical contact can be established prior the process of the mechanical bonding of the component and the surface. The bonding of the measuring element with measuring object can then be carried out very efficiently.

The problem is solved by way of example as follows. On the component to be mounted a layer sequence of materials is applied by means of coating methods. These materials are selected that local energy exposure exothermic reaction is initiated. The materials evolved from the reaction, or the added materials in the intermediate layer, lead to a mechanically solid link between component and surface. The reaction rate has to be selected high such that the heat loss by conduction does not result in abating of the propagation of the reaction. Thus, very short installation times can be achieved. Furthermore, it is ensured that other areas of the component face only a slight warming. Thus, an electrical contact remains functional after the mechanical installation of the component.

Alternatively, further bonding methods are applicable alternatives. Thus, adhesive layers that are pre-structured on the measuring element, can achieve similar high shear strengths. The advantages of an easy installation and reproducible layer thickness can be achieved in the same manner.

Further advantages, features and characteristics of the invention will become apparent from the following description of preferred embodiments of the invention with reference to the accompanying drawings.

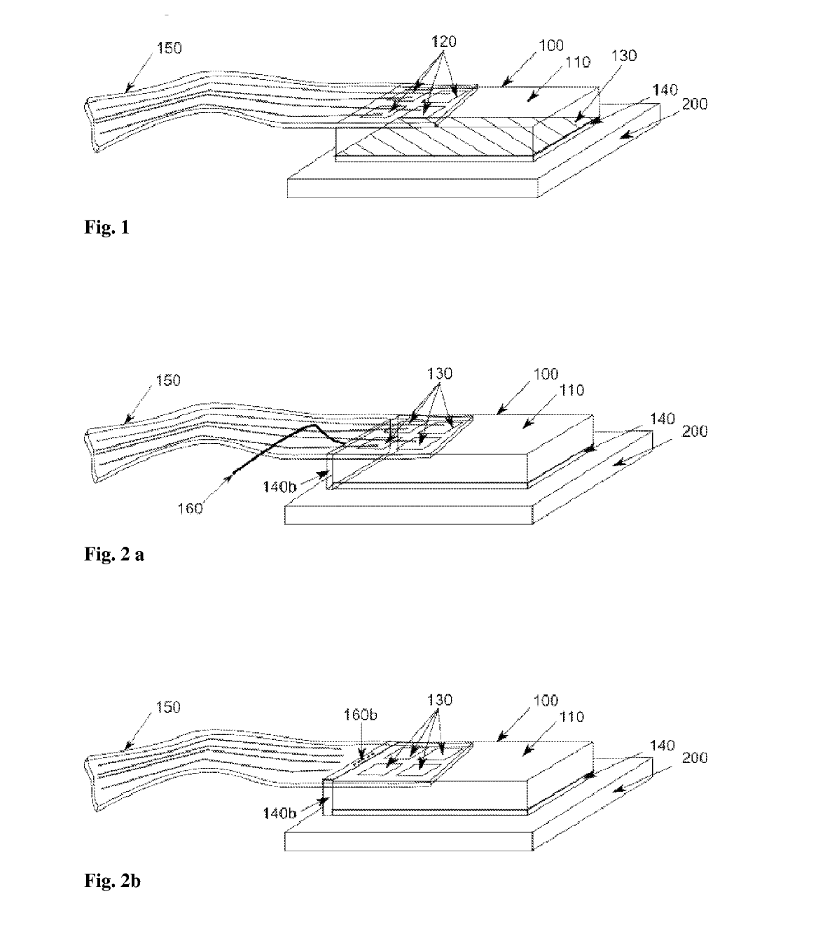

FIG. 1 is a view of a schematic overall configuration of a measuring element according to the invention (100) which is applied to the measurement object (200), wherein the auxiliary electrical contacts (150) are designed as flexible interconnects.

FIG. 2A is a view of a measuring element according to the invention (100) with electrical activation of the functional material (140), wherein the activation of the functional material (140, 140b) is performed over an auxiliary contact (160). The electrical leads are partially removed for clarity.

FIG. 2B is a view of a measuring element according to the invention (100) with electrical activation of the functional material (140), wherein the activation of the functional material is performed (140, 140b) over the existing electric auxiliary contacts (150).

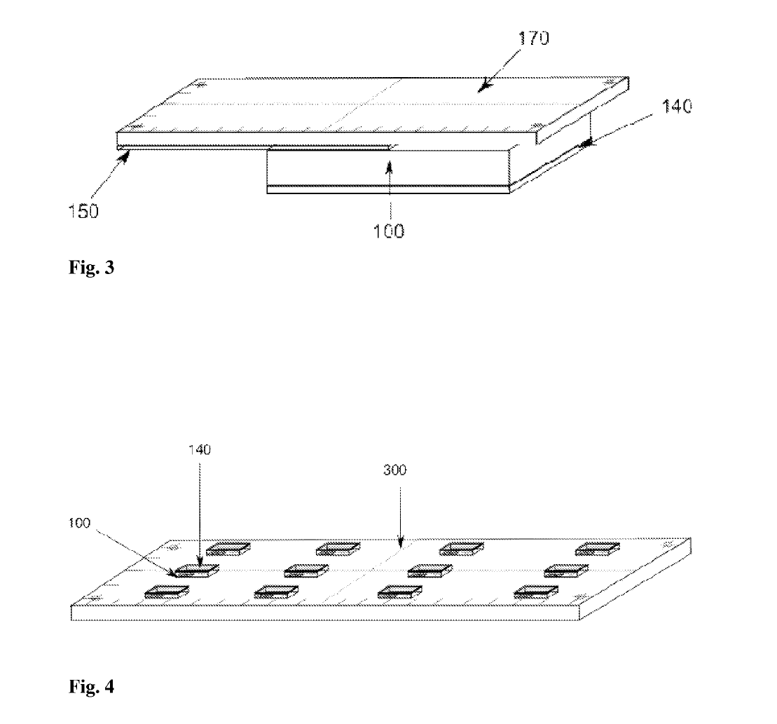

FIG. 3 is a view of an installed measuring element (100) according to the invention with a protective cover (170) still present.

FIG. 4 shows a plurality of measurement elements (100) applied on a carrier material (300) prior to installation to one or more measurement objects (200).

The installation of strain sensors at test elements (200) is elaborate. Therefore, the surface of the object (200) has first to be cleaned chemically, then glue is applied. After that a defined pressure for a defined period of time has to be applied to the sensor, whereby the adhesive layer thickness decreases and is set to its final thickness. Thereafter, a curing of the adhesive at elevated temperature in the furnace is performed. Meanwhile, either during setting of the adhesive thickness as well as during curing, the measuring element must be pressed and accurately held in position. Quite often an installation at inaccessible areas is possible only with difficulties. The curing of the adhesive layer in the oven is difficult or even impossible with at test elements (200), which have a high heat capacity or large dimensions. Thus, the installation of strain gauges has turned out to be complex so far.

FIG. 1 shows an inventive measuring element (100), whereby the preferred embodiment is a semiconductor silicon measuring element. One or more resistors—generally referred to as sensor elements (110)—are integrated into the measuring element. These respond to mechanical stresses and change their electrical resistance, whereby the mechanical stress and strain of the measuring element (100) becomes measurable. The resistors can be supplied with voltage and current by electrical auxiliary contacts (150) and the output of the resistors or of the resistor circuitry can be detected externally.

The measurement element (100) has a connecting surface (130). A functional material (140) is coated with a known thickness onto that connecting surface (130)—preferably by the manufacturer of the measuring elements (100).

In a preferred embodiment the functional material is of known reactive nano materials. In this case, the activation can be carried out by applying an electrical voltage to the layer of functional material. An exothermic reaction occurs and the functional material causes the bonding of the joining surfaces of the measuring element (100) with the object to be measured (200). Due to the short-term strong local heat generation, chemical residuals at the interfaces, especially on the measurement object (200), are locally destroyed. Thereby a mechanically stable bonding can be realized without complex pre-cleaning. In general, the exothermic reaction is effected in a very short time in the millisecond range. Thereby a positioning, pressing and holding of the measuring element is necessary only over very short duration. By that measuring elements (100) can be installed on test element (200) in a short time and with little effort. Further materials can be added to the functional substance (140) which allow a mechanical stable bonding. Therefore, solders are useful, for example. In particular all functional substances can be applied which allow welding of the measuring element (100) and the test object (200).

Future material combinations can be for example REDOX combinations of iron oxide and a reducing agent which are applicable for the measuring elements (200) having a steel surface. Or REDOX combinations of silicon oxide with a reducing agent can be applied to produce a welded connection with the measuring element (100). The functional substance is not limited to reactive nano layers. Also adhesives can already be applied at the measuring element (100). This would also lead to a simpler installation as well as to a reproducible adhesive layer thickness and is included in claim 1 of the measuring element according to the invention.

FIG. 2a shows a measuring element (100) with an additional contact to activate the function material (140). Also, several additional contacts (160) can be attached.

Cost-effective and easy to implement are also contacts for activating the function material (160) by using the existing electric auxiliary contacts for electrical activation. FIG. 2b shows such an example. The auxiliary contacts are exposed at the measuring element. By application of electrical voltage the functional material (140b) at the rear edge of the measuring element (100) can be activated. Activation then proceeds through the functional material (140b), further on through the function material (140), whereby the measuring element (100) is connected with the test object (200). The ignition can be implemented in such a way that the auxiliary contacts lie against the functional material (140b). After activation by an electrical voltage the functional material (140b) obtains high impedance and does not affect a measurement by the measuring element any more or only slightly. Alternatively, the activation can be performed by an electrical resistor (160b) at the electric auxiliary contacts above the functional material (140b)—which in the simplest case is built from thin conductor section between the electric auxiliary contacts (150). After activation, this resistance has a very high impedance and no longer affects a measurement with the measuring element (100).

For strain measurement by means of measuring elements (100), the measuring elements should be thin—optimally in the range of 10 μm to 50 μm—in order to detect the strain in the test object (200) with the measuring elements (100) as well as possible. But the small thickness of the measuring element (100) also involves a low mechanical stability. In order to protect the measuring elements during transportation, but especially during installation to the measuring object (200) from damage, a cover (170) on the measuring element (100) is optionally provided. In the preferred embodiment this cover (170) is designed as a piece of mechanically stable material. The mechanical protection is preferably made transparent so that an exact positioning of the measuring element (100) on the measuring object (200) is possible easily. Preferably, the cover (170) has alignment marks as well as line elements for measuring distances. In order to press the measuring element (100) onto the measuring object (200) in the application, a soft intermediate layer may be provided between the cover (170) and the measuring element (100). The cover (170) may remain on the measuring element (100) after the application of the measuring element (100). But for particularly precise measurements it should be removed. In the simplest case the cover (170) can be easily removed.

By integration of electronic circuits on or in the measuring element (100) a variety of advantages can be achieved. For example, the output signal of the sensor elements can be pre-amplified or optionally digitally converted. As a result, the signal-to-noise ratio is significantly improved. Biggest advantages can be achieved by electrical circuits integrated in the measuring elements whereby an interface to a bus system is integrated. This allows operating a large number of measurement elements at a few auxiliary electrical contacts. In this way the measuring element (100) according to the invention is particularly advantageous for use in applications with multiple measuring points.

FIG. 4 shows such a system. Mounted on a substrate (300) numerous inventive measuring elements (100) are pre-applied mechanically and are electrically contacted.

Due to the electronic circuits in each measurement element (100) only very few auxiliary electrical contacts (150), in the proposed case two to four, are required. The entire matrix, i.e. substrate (300) with the measuring elements (100) and the electric auxiliary contacts (150), can be positioned and installed on the object to be measured in one step. To the same extent this can be done also when no electrical circuitry on or in the measuring element (100) is integrated. Then more electric auxiliary contacts (150) are required.

The measuring elements (100) can be installed to test objects (200) very easily and very fast, contrary to the prior art. It may nevertheless be of great advantage to install the measuring elements with a tool. For this purpose, an abutment region for the measuring element (100) is provided. This abutment region is advanced with a defined force or deviates from the prescribed pressing direction. The defined force is maintained until the activation of the material (140) is complete. The installation tool comprises an activation function, by which the functional substance (140) can be activated. For example, this can be electrical contacts that activate the function material (140b) by means of electrical voltage, a targeted laser pulse or the input of microwaves. In the preferred embodiment, the installation tool comprises specific areas which prevents slippage of the installation tool during the bonding process of the measuring element (100) with the measurement object (200).

Alternatively switched-magnetic forces can prevent slippage of the installation aid during the connection process.

Even if the structure of the measuring element shown in FIGS. 1 to 4, is the easiest, and for the main number of applications is the most practical implementation, an embodiment of the measuring element (100) may also be advantageous in which the functional substance (140, 140b) is arranged on the same side as the primary electrical contact areas (120) or on the same surface as the auxiliary electrical contacts (150).

Furthermore, it may be advantageous to pre-treat the surfaces of the test object (200) on which the measuring element (100) is to be applied.

Thus, applying a thin layer of silver solder or other known stainless steel solder on a measuring object (200) made of stainless steel is possible. Subsequently, by means of the reactive layers the sensor can be assembled very simple, very fast and with high strength on the stainless steel carrier, which is nearly or completely cooled, without impairing the previously prepared electrical contacts (150) of the measuring element (100).

In a further embodiment, in the measuring element (100) electrical trough contacts are provided, which allow a current flow from the surface at the far side regarding to the measuring object (200) to the functional material (140). In the same way, a hole in the measuring element (100) may be provided in order to activate the functional material (140) by laser light penetrating this hole. As functional materials (140), conventional reactive nano-films [3] can be used. These are made of an alternating layer system and are coated with an additional metallic solder. This solder is electrically conductive. In order to achieve an electrical activation, in a preferred embodiment the solder layer is selectively removed under the contact areas to prevent a current flow through the solder layer. This powers the reactive layers only and thus activates the reactive layers with lower power consumption.

As reported, it is possible to use, for example, reactive layer systems such as according to [3]. In order to achieve good adhesion of the nano-film on measuring elements (100) made of silicon, the silicon-measuring element (100) can be provided with an adhesive layer, e.g. nickel, chromium and nickel, or gold. Optionally a further solder layer can be applied to the measuring element.

In a further embodiment of the invention, in turn the measuring element (100) consists of silicon and has a coating of nickel on the side facing the measuring object (200). The functional material (140) consists of a layer system of reactive nano films with a lamination of aluminum and nickel. On the layer composite of the reactive nano foils a solder layer is applied on both sides. At the points of electrical contact to the measuring element (100) the solder layer is opened. On these openings gold contacts are provided by wire bonding or by known chemical or physical processes (Under-Bumb-Metallization). During assembly, these contacts coincide with the through hole contacts of the measuring element, or alternatively they will lie in the area of in the area of the functional material (140b) and replace it at least partially. In this way these contacts allow the electrical activation of the functional substance (140). Alternatively, in the measuring element (100) through hole contacts are introduced into the measuring object (200), whereby the through hole contacts extend from the connecting surface to the side facing the measuring object (200). On the side facing the measuring object (200) an adhesion layer, for example of chromium and nickel, is textured, but this layer spares the through contacts. The functional substance (140) i.e. the layer system of the reactive nano films is either directly deposited onto the adhesion layer or a solder layer is applied. When using a solder layer the through hole contacts are spared from coating in order to prevent a short circuit by the solder layer. Onto the through contacts metal layers are deposited, which have a slightly greater height (about 2 microns) than the solder layer. In this way, by placing on or respectively by pressing the measuring element (100), the measurement object (200) and the layers and contacts, which are arranged in between, an electrical contacting of a reactive functional material (140) becomes possible. Preferably, the metal layers for the bonding are build from metals with a low melting point. So they melt after the activation of the reactive layers, and by a pressing the measuring element (100) onto the measuring object (200), the distance of the two bodies is reduced, and a mechanically stable connection is produced, and the measuring element attaches the measurement object with the hole contact surface.

In one preferred embodiment, the measuring element (100) is already connected with the functional material (140) upon delivery to the customer. But it is also possible that individual components, such as measuring element (100) and functional material (140) are supplied in an unconnected status. For positioning the measuring element (100) and the functional substance (140) accurately on the measurement object (200) then adjustment areas, for example depressions and/or mechanical stops in the functional material (140) or alternatively in the measuring element (100), are advantageous for the alignment and assembly of measuring element (100) with the functional material (140).

The descriptions are carried out as an explanation of the process and are applicable in various combinations and variations.

### LITERATURE

[1] Noise, J.: Development and application of miniaturized piezoresistive strain gauge elements, EMK dissertation series Vol. 25, Technische Universität Darmstadt, Institute for Elektromechanical Design, Darmstadt, ISBN 978-3-8439-0553-4 [Book] (2012).

[2] First Sensor Technology: T-bridge. http://www.first-sensor.com/.Version: 2012

[3] Indium Corporation: nanofoil and Nano Bond. http://www.indium.com/techlibrary/whitepapers/.

### REFERENCE SIGN LIST

100 measuring element

110 sensor elements

120 primary electrical contact areas

130 connecting surface

140 functional material

140b functional material

150 electrical auxiliary contacts

160 additional Contact

160b additional resistance

170 protective cover

200 test object, measuring object

300 support material

1. Measuring element (100) for measuring quantities, characterized in that
the measuring element (100) has at least one connecting surface (130) which is provided with a functional material (140), through which a connection to the test object (200) is established, whereby the connecting surface (130) allows a force coupling between the measuring element (100) and the test object (200).

2. Measuring element (100) for measuring quantities according to claim 1, comprising auxiliary electrical contacts (150), wherein the auxiliary electrical contacts (150) are connected with the measuring element (100) and lead away from this, with the aim to allow a simplified electrical contact to a measurement system, characterized in that
the auxiliary electrical contacts (150) are attached to the measuring element (100),
and subsequently the connection to the test object (200) is made, wherein the auxiliary electrical contacts (150) have a low contact resistance after the connection to the test object (200) has been made.

3. Measuring element (100) according to claim 1, characterized in that the functional material (140) for producing the connection can be activated by electric voltage, light, heat, pressure, microwaves, or other physical or chemical quantities.

4. Measuring element (100) according to claim 3, characterized in that the functional material (140, 140b) is activated electrically, and that the electric voltage is induced via at least one of the auxiliary electrical contacts (150) or via at least one supplementary contact (160).

5. Measuring element according to claim 1, characterized in that a protective cover (170) is applied at the measuring element, whereby the cover protects the measuring element (100) against excessive mechanical stresses during transport and during installation.

6. Measuring element (100) with a cover (170) according to claim 5, characterized in that said cover (170) is at least partially transparent or contains markings or comprises grooves or mechanical stops, so that the positioning of the measuring element (100) on the test object (200) or inside an application tool is simplified.

7. Measuring element according to claim 1, characterized in that at or in the measuring element (100) at least one electric circuit is present, which allows a signal preprocessing and/or a signal transmission and/or energy supply.

8. Application of the measuring element (100) according to claim 1, characterized in that a plurality of sensing elements is applied on a support material (300) and are electrically contacted, and the measuring elements (100) can be connected to one or more measurement objects (300).

9. Installation tool for measuring elements (100) of claim 1, characterized in that it allows the positioning of the measuring elements (100) on the test object, that it exerts a mechanical pressure on the measuring element (100) and that it performs the activation of the functional material (140, 140b).

10. Method for the installation of measuring elements (100) for detecting measured quantities according to claim 1, characterized in that
the measuring element (100) is positioned on the measurement object (200) and is brought into contact with this,
wherein the functional material (140, 140b) is activated before, during or after the positioning.
